(19) United States
(12) Patent Application Publication
(10) Pub. No.: US 2011/0096149 A1
(43) Pub. Date: Apr. 28, 2011

(54) VIDEO SURVEILLANCE SYSTEM WITH OBJECT TRACKING AND RETRIEVAL

(75) Inventors: Sze Lok Au, Hong Kong Sar (CN); Jesse Sheng Jin, Hong Kong Sar (CN)

(73) Assignee: MULTI BASE LIMITED, New Territories (HK)

(21) Appl. No.: 12/746,556

(22) PCT Filed: Dec. 7, 2007
(86) PCT No.: PCT/CN2007/003492

§ 371 Date: Jun. 7, 2010

(51) Int. Cl. H04N 13/02

(52) U.S. Cl. 348/47; 348/E13.074

(57) ABSTRACT

A system for capturing and retrieving a collection of video image data captures video image data from a live scene with still cameras and PTZ cameras, and automatically detects an object of interest entering or moving in the live scene. The system automatically controls the PTZ camera to enable close-up real time video capture of the object of interest. The system automatically tracks the object of interest in the captured video image data and analyses features of the object of interest.

### BACKGROUND OF THE INVENTION

The present invention relates to video surveillance, object of interest tracking and video object of interest retrieval. More particularly, although not exclusively, the invention relates to a video surveillance system in which close-up images of an object of interest are taken automatically by zoom-in cameras and specific video clips are automatically selected and retrieved dependent upon their content.

Large numbers of CCTV cameras are installed in private and public areas in order to perform security surveillance and facilitate video recording. Recorded video clips have proved to be very useful in tracking movements of crime suspects for example. As more cameras are installed for surveillance and security purposes in the future, the amount of video information stored will increase dramatically.

Current CCTV security systems are based on non-calibrated still cameras or manually operated Pan-Tilt-Zoom (PTZ) cameras. Such systems provide limited functionality and in particular provide merely a passive video stream for recording or live real-time control room observation. Objects of interest cannot be automatically detected and no close-up images of an object of interest such as a suspect's face are recorded automatically in real-time. In order to provide a close-up image of a suspect's face for example with such systems a control room operator must manually steer a PTZ camera toward the object of interest. Otherwise, labour-intensive post-event viewing and retrieval of the record video stream must be undertaken. It is then very difficult to identify a suspect's face, especially if the video image of the face takes up but a small portion of the overall video screen, which when blown-up becomes very grainy.

Furthermore, current CCTV surveillance records provide a passive constant recording when there is no activity in the scene. There are no known techniques to retrieve the required video records automatically from the vast video record. In the current state of the art, operators perform labour intensive manual screening to retrieve the required video. As the number of installed cameras increases, so does the amount of video and hence the amount of manual labour required increases accordingly.

### OBJECTS OF THE INVENTION

It is an object of the present invention to overcome or substantially ameliorate at least one of the above disadvantages and/or more generally to provide a video surveillance system with object tracking and retrieval in which close-up video images of objects of interest are recorded in real-time. It is a further object of the present invention to provide such a system in which relevant recorded video clips can be retrieved automatically.

It is an object of the present invention to provide a method and a system for intelligent CCTV surveillance and activity tracking. The system involves the use of calibrated still and PTZ cameras.

The system provides functions to zoom-in and take close-up photos of any object of interests, such as any person that newly enters into the view of the camera. This feature is performed on-line in real time. During off line activity tracking, relevant video records that are captured from multiple cameras to form an activity list of the object of interest over a long time span.

### DISCLOSURE OF THE INVENTION

In a first broad form, the present invention provides a method of capturing and retrieving a collection of video image data, comprising:
capturing video image data from a live scene with still CCTV and PTZ cameras; and
automatically detecting an object of interest entering or moving in the live scene and automatically controlling the PTZ camera to enable close-up real time video capture of the object of interest.

In a second broad form, the present invention provides a method of capturing and retrieving a collection of video image data including the steps of:
capturing video image data indicative of a live three-dimensional scene using at least two calibrated still CCTV cameras;
automatically identifying an object of interest within the live three-dimensional scene based on the video image data captured by the at least two calibrated still CCTV cameras;
calculating three-dimensional coordinates representing a position of the object of interest within the live three-dimensional scene; and
controlling a PTZ camera, which is calibrated with the at least two CCTV cameras, to automatically capture close-up real-time video image data of the object of interest within the live three-dimensional scene by reference to the three-dimensional coordinates representing the position of the object of interest.

Preferably, the method further comprises automatically tracking the object of interest in the captured video image data and/or in real time.

Preferably, the method further comprises automatically analysing features of the object of interest.

Preferably, the method further comprises automatically searching existing video databases to recognise and/or identify the object of interest.

Preferably, the method further comprises constructing an activity chronicle of the object of interest as captured.

Preferably, the cameras are calibrated such that a three-dimensional image array can be computed.

3D static camera calibration is referring to an offline process which is used to compute a projective matrix, such that during online detection, a homogenous representation of a 3D object point can be transformed into a homogenous representation of a 2D image point.

PTZ camera calibration is a more complex task. This is because, as the camera's optical zoom level changes, its intrinsic camera value will change. And as the camera's pan and tilt values change, the camera's extrinsic value will change. Therefore, we must adopt an accurate method which searches a relationship between the angular motions of a PTZ camera's centre when it undergoes mechanical panning and tilting changes.

Preferably, segmentation of the three-dimensional array is performed by background subtraction.

Preferably, the object of interest is a person's face, and the PTZ camera is controlled automatically to take a close-up image of the face.

Preferably, the method further comprises implementing a scheduling algorithm to control the PTZ camera to identify and track a plurality of objects of interest in the scene.

The Preferably, the method further comprises implementing a compression algorithm using background subtraction, and implementing a decompression algorithm using multi-stream synchronisation.

Preferably, the method further comprises implementing a semantic scheme for video captured by the still CCTV camera.

Preferably, the method further comprises observing a monitor that can display non-linear and semantic tagged video information.

In broad terms, the system is designed to automatically detect an object of interest, automatically zoom-in for close-up video capture, and automatically provide activity tracking.

Preferably, the calibration process enables the set of cameras to be aware of their mutual three-dimensional interrelationship.

The detecting and zooming-in preferably comprises segmenting the image data into at least one foreground object and background objects, the at least one foreground object being the object of interest. The object of interest is preferably a person or vehicle that newly enters into the scene of the captured video image. Detection typically further comprises recognising a human and detecting and determining the locations of its face.

The zooming in typically comprises calculating the location of the face of the object of interest and physically panning, tilting and/or zooming the PTZ camera to capture a close-up picture of the object of interest. At this stage, the invention will concentrate on people and moving vehicles which are the important objects of interests.

In the case that more than one object requires video-capturing, the detection can comprise a scheduling algorithm which identifies human faces or moving vehicles and determines the best route to take close-up video images such that no object of interests will be missed.

The tracking preferably comprises segmenting the image into foreground and background, detecting objects of interest and tracking the movements of objects of interest in the video images.

Each pixel is automatically classified as either foreground or background and is analysed using robust statistical methods over an interval of time. The tracking produces a record of activity locus of the object of interest in the image.

The video analysis would typically comprise analysing and recording the physical features of the objects of interest. Features including but not limited to model of vehicle, registration plate alphanumeric information, style and colour of clothing, height of the object of interest and the close-up video shot will be analysed and recorded in order to perform recognition of the object of interest.

The recognising and searching preferably comprises matching the recorded set of analysed physical features to search for potential objects of interest in other captured video images.

In the vast amount of video records, records are first temporally and physically filtered such that only those videos that potentially contain the object of interest would be subjected for object recognition and searching.

The creating step preferably comprises collecting all video data relevant to the object of interest captured from multiple cameras, arranging the videos in a manner such that an activity chronicle can be produced. The activity chronicle preferably further can sync to the positions of the cameras, creating an activity chronicle of physical locations. This comprises mapping physical installation locations of the cameras over the surveillance area to the retrieved relevant video records.

Also envisaged is a computer program for carrying out the methods of the present invention and a program storage device for the storage of the computer program product.

Also envisaged is a video compression method which offers a large compression ratio to save large amounts of storage space. The compression method will comprise activity detection and background subtraction techniques.

Also envisaged is a video decompression program which comprises an algorithm that uses multi-stream synchronisation.

Although this invention is applicable to numerous and various domains, it has considered to be particular useful in the domain of security surveillance and tracking for suspects.

The methods and systems of the present invention are particularly suited to track a suspect of interest whose activities are recorded by a plurality of cameras. For security purposes, it is common that security staff is required to retrieve all the recorded video of a suspect of interest over a particular time frame, from a web of cameras installed over a venue or a city area. The resultant image data can be used to build an activity chronicle of the suspect which would be of great value to the investigation of the suspect and the associated event.

The methods and systems of the present inventions would produce a clear close-up picture of a suspect(s) and perform relevant video retrieval with reduced labour and much shorter time frame. The reduced time lead will be essential to organisations such as police departments.

In a third broad form, the present invention provides a computerised system adapted for performing any one of the method steps of the first or second broad form.

In a fourth broad form, the present invention provides a computer-readable storage medium adapted for storing a computer program executable by a computerised system to perform any one of the method steps of the first or second broad forms.

In a fifth broad form, the present invention provides a PTZ camera adapted for use in accordance with any one of the method steps of the first or second broad forms.

### DEFINITIONS

As used herein the terms “object(s) of interest” and its abbreviation “OoI” are intended primarily to mean a person or people, but might also encompass other objects such as insects, animals, sea creatures, fish, plants and trees for example.

As used herein, the term “CCTV camera(s)” is intended to encompass ordinary Closed Circuit Television cameras as used for surveillance purposes and more modern forms of video surveillance cameras such as IP (Internet Protocol) cameras and any other form of camera capable of video monitoring.

### BRIEF DESCRIPTION OF THE DRAWINGS

A preferred form of the present invention will now be described by way of example with reference to the accompanying drawings, wherein:

FIG. 1 illustrates schematically the general design architecture of a video surveillance system with object tracking and retrieval;

FIG. 2 illustrates schematically details of image segmentation and 3D view calibration and calculation;

FIG. 3 illustrates schematically the detailed operational flow of the relevant video retrieval process; and

FIG. 4 illustrates schematically the technical details of the relevant video retrieval process.

### DESCRIPTION OF THE PREFERRED EMBODIMENT

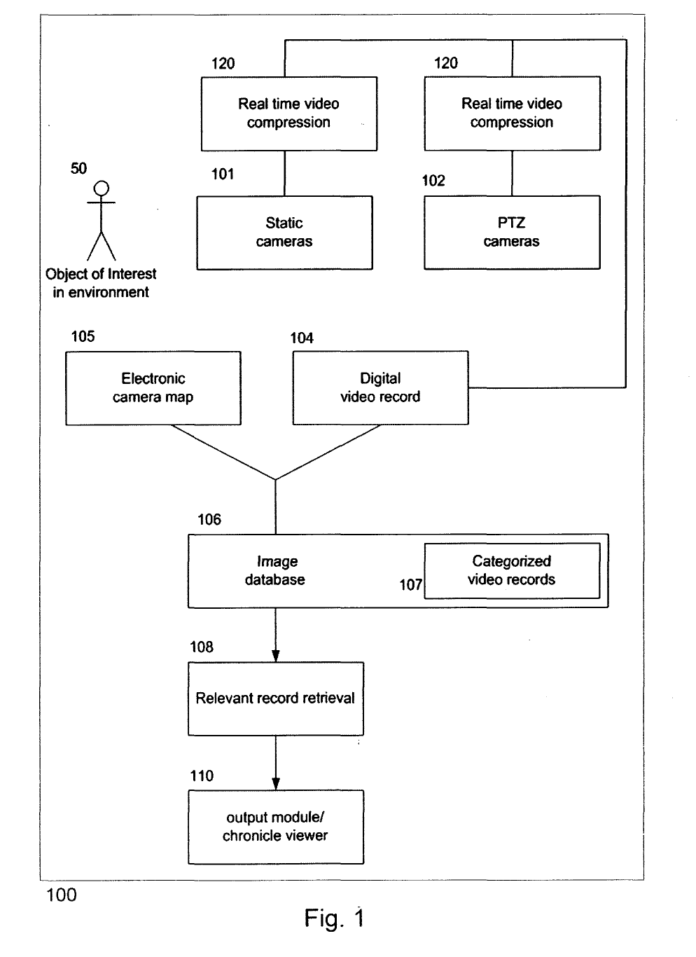

FIG. 1 of the accompanying drawings depicts schematically an overview of a system for carrying the methods of the present invention. The system 100 comprises a plurality of cameras 101 installed in strategic locations for monitoring a targeted environment or scene 50. Optical pan-tilt-zoom and/or high resolution electronic pan-tilt-zoom cameras 102 are installed at locations where close-up pictures of objects of interest are to be captured automatically. The cameras form a monitoring network where prolonged activity of an object of interest over a large physical area can be tracked.

Cameras 101 and 102 are calibrated such that the 3D position of objects of interest within the monitored area can be calculated. The 3D camera calibration can be achieved using 2D and 3D grid patterns as described in [Multiview Geometry in Computer Vision by R. Hartley and A. Zisserman, Cambridge University Press, 2004].

Under circumstances where a plurality of human faces require video capture, a scheduling system is employed to determine the fastest sequence to capture close-up images in order not to miss any object of interest. It is appropriate that a scheduling algorithm such as a probability Hamilton Path is implemented for this feature. Each moving object is attached to a probability path based on its moving speed, 3D position and direction of movement. A graph algorithm will determine a Hamilton Path of all objects and decide the best location to capture a close photo of each without occlusion.

Although single camera 101 or 102 can be used in the methods and system of the present invention, images from multiple cameras 101 and 102, when available, is preferably combined to form multiple views for processing.

The output of the cameras 103, that is, the captured video records, is recorded in a digital video recorder 104. The captured video records 103 are to be saved in an electronic format. Hence, cameras 101 and 102 are preferably digital cameras. However, analogue cameras may also be used if their output is converted to a digital format. Module 120 performs compression of the output video data of the cameras 103. The compressed captured video record is saved by the digital video recorder 104.

Whenever an object of interest enters the surveillance area (scene), the PTZ camera is controlled to automatically zoom in to receive a close-up image. The image is then saved in the data base 106.

The present invention also makes use of high ratio compression techniques to reduce data-storage requirements. Considering the large number of cameras installed and the volume of video data to be produced, high rate compression is a practical necessity. Video compression is a common art. The present invention prefers a techniques making use of background subtraction. This technique involves activity detection and background subtraction. The activity detection identifies if there is any activity in the video scene. If there is no activity, the video segment is completely suppressed. If there is an activity, the minimum enclosing active area of a period will be compressed and stored. A synchronisation file using Synchronised Accessible Media Interchange (SAMI) is stored for video decompressing.

Preferably, video compression is to be performed in real time. The compression process is preferably carried out directly after the image is captured by the camera and before the video data been recorded. Therefore, the video database can record already-compressed video data. The video compression process 120 can be performed by a compression algorithm which can be implemented either by embedded hardware placed within the cameras or a computer device placed in between the cameras and the digital video servers can perform the compression task.

It is important that the video compression process makes use of background subtraction and exploits object tracking techniques while the video analysis makes use of the same techniques. The video compression is typically performed on raw captured video closely coupled with the cameras. Video information is saved in a compressed format on a video server. The saved data is already segmented and indexed, and can be used for data searching and browsing. The result is that the video compression and content analysis process are performed essentially as one process as compared to a typical “capture-record-compress-analyse” sequential procedure.

The physical locations of cameras 101 and 102 are synchronised to an electronic map 105. Based on the cameras physical location information from the electronic map 105, the system arranges video records 103 and saves them in a database 106. The video records 107 in the database 106 will be temporally and geographically categorised and indexed.

A software module 108 provides features to recognise and track an object of interest from a simple video record; to analyse and search for the object of interest from the multiple captured video records; and create an activity chronicle 110 of the object of interest and output the results to users.

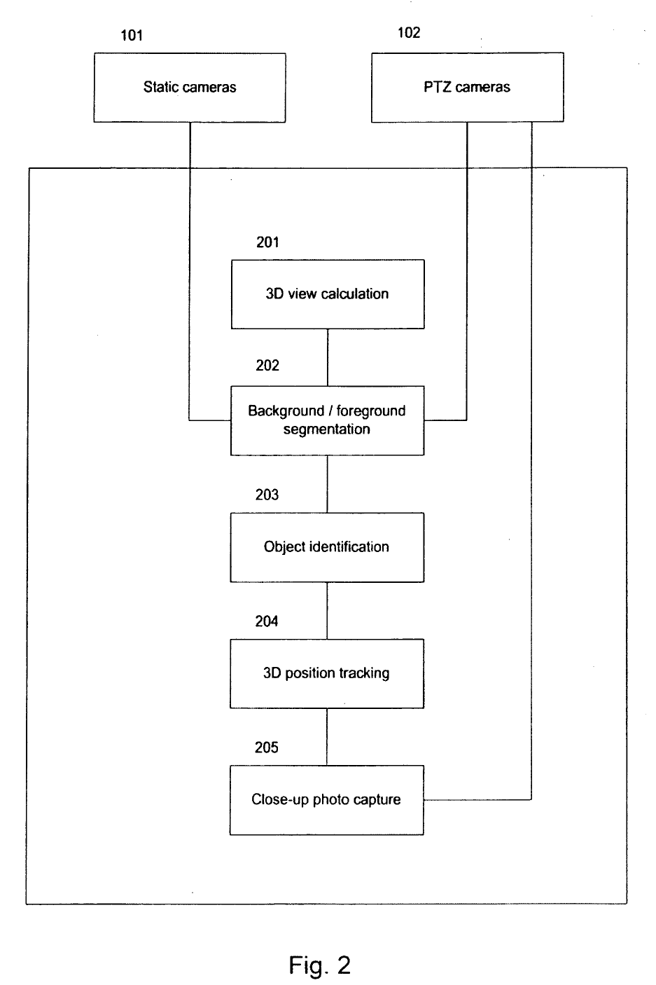

Referring to FIG. 2, after image data has been captured for a scene, relevant objects, preferably human, have to be extracted from raw video for close-up image taking. The extraction of relevant objects from image data would typically comprise three processes, namely: 3D view calculation; segmentation; and object identification.

3D calculation produces a 3D point from the corresponding image points of the two 2D cameras. The two 2D cameras are to be calibrated during installation. Calibration can be done using techniques described in [Multiview Geometry in Computer Vision by R. Hartley and A. Zisserman, Cambridge University Press, 2004]. 3D point calculation can be computed to determine the intersection of imaginary rays from the two camera centres.

Segmentation detects objects in the image data scene. Implementation makes use of techniques such as background subtraction, which classifies each pixel into moving parts and static parts to report foreground objects. There is a number of techniques to implement background subtraction such as [“Adaptive Background Mixture Models for Real-time Tracking” by C. Stauffer and W. Grimson, IEEE CVPR 1999] and [“An Improved Adaptive Background Mixture Model for Real-time Tracking with Shadow Detection” by P. KaewTraKulPong and R. Dowden, 2nd European Workshop on Advanced Video Based Surveillance Systems, 2001].

Object identification involves detecting required features to be presented as a foreground object. The present system takes close-up images of any human who enters into a scene, while tracking other objects. Human recognition can be done by detection of characteristics unique to humans, such as facial features, skin tones and human shape matching. Techniques such as using the Adaboost of Haar-like feature training as described in [“Rapid Object Detection using a Boosted Cascade of Simple Features” by P. Viola and M. Jones, CVPR 2001] are commonly used for human and human face detection.

Once a human or a vehicle is identified, a close-up image of the face of the target human or the number plate of the target vehicle would be taken. This involves a 3D position tracking of the human face or the number plate which instructs the PTZ camera to take close-up images. 3D position tracking involves calculating the exact position of the target object based on the pre-calibrated camera.

Techniques such as epipolar-geometry are considered to be suitable for 3D position calculating. Once the exact 3D location of the target object is found, instruction to drive the PTZ camera to take close-up photos can be sent automatically using common PTZ protocols such as RS232, or TCP/IP. It can also be embedded in the video data stream and sent to archive.

A calibration algorithm has been developed using multi-view geometry and randomised algorithms to estimate intrinsic and extrinsic parameters of still cameras and PTZ cameras. Once the cameras are calibrated, any 3D position can be identified and viewed using a 3D affine transform. A zoom-in algorithm has been developed using a 3D affine transform. A background subtraction algorithm has also been developed using dynamic multi-Gaussian estimation. Combining background subtraction and 3D affine transform enables automated pan, tilt and/or zoom to a personal face or a car number plate to take a close-up image record. The face and number plate identification are achieved using a mean-shift algorithm.

Under circumstances when the surveillance area expects a large crowd of people, it is advised that a scheduling module is integrated into the system such that the PTZ cameras could manage to take photos of all targets in the shortest possible time. Scheduling and maximisation is a common art, such as that disclosed in [Computational Geometry, Algorithms and Applications by Mark de Berg, Marc van Kreveld, Mark Overmars, and Otfried Schwarzkopf, Springer-Verlag, 1997].

Similarly, the system handles occlusion effects. The methods of the present invention preferably use a scheduling algorithm base on a probability Hamilton Path.

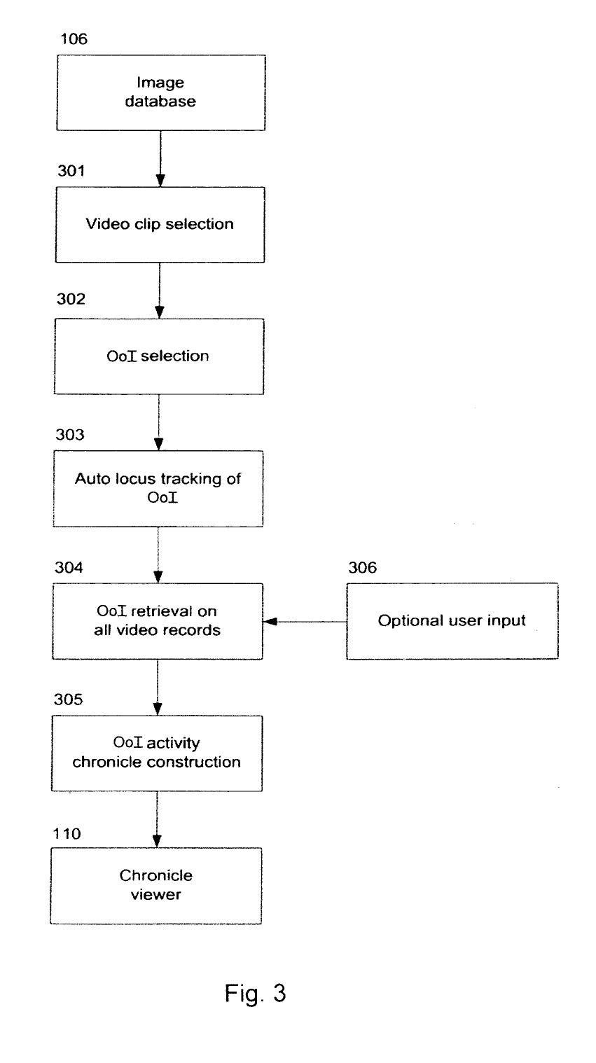

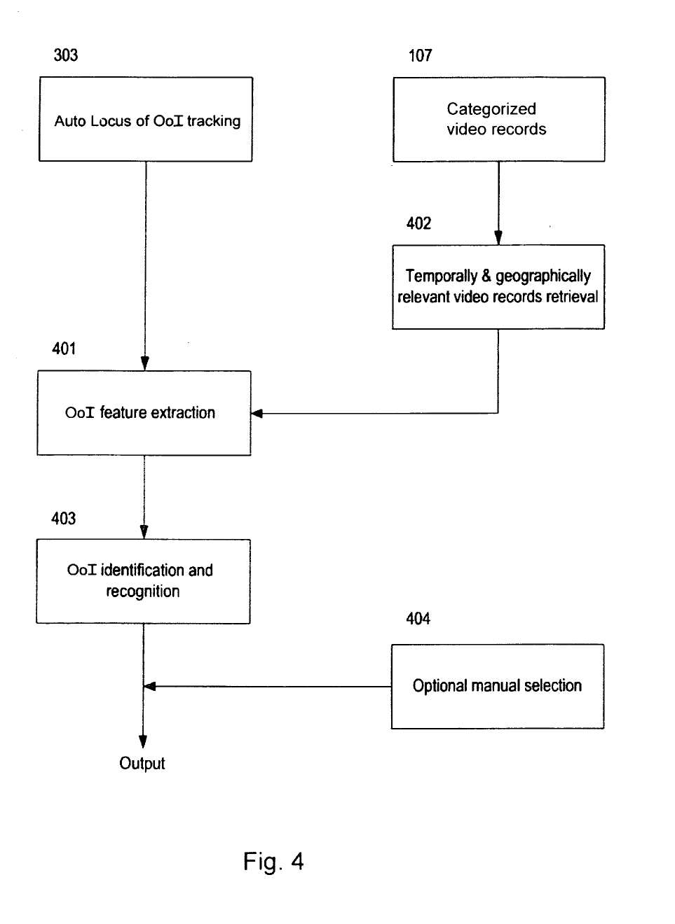

FIG. 3 illustrates the detailed operational flow of modules 108. Module 301 selects a video clip to act as a seed for the object tracking operation. Module 302 selects the object of interest, preferably human, to be recognised and tracked. Module 303 traces the activity locus of the object of interest in the video records from 302. This process involves object identification, recognition and image data retrieval. Detailed technical discussion will be provided in reference to FIG. 4.

After the object of interest is recognised and tracked in module 303, module 304 then performs operations to retrieve all video data that contains the object of interest. The video retrieval operation performed in module 304 can be done either fully automatically or manually 306. In order to balance between operation time and accuracy, it is preferable that process is done with automatic retrieval supplemented with manual selection or a combination of both.

Retrieved video records are piped to module 305 for activity chronicle creation. An activity chronicle is a historical documentation of the activity performed by the object of interest as captured by multiple cameras. The video records are temporally and geographically arranged so as to create a clear record of evidence of what the object of interests has done within the specified period of time. Video data arrangement can be performed using techniques such as spatial and temporal database manipulation. A visualisation algorithm is developed to provide a view of the travelling path of the object of interest.

The activity chronicle is to be viewed on a chronicle viewer (monitor) 110. The chronicle viewer preferably can view non-linear and semantic tagged video records.

FIG. 4 technically illustrates tracking modules 303 and 304. It also depicts how the system retrieves all relevant video records that contain the object of interest. Module 303 produces the activity locus of the said object which involves preferably with blob tracking. Blob tracking is a common technique using region growing. The centre of a bounding box of the object of interest can be used as the trajectory of the object.

Results generated from module 303 provide information to the system to look for relevant video records from the categorised image database 107. Module 401 performs feature-extraction for the recognised object. Useful information such as the height, colour of its clothing, skin colour, motion pattern, etc, will be learned and collected in this process. Feature-extraction can be done using statistic and machine learning techniques such as histogram analysis, optic flow, projective camera mapping, vanishing point analysis, etc.

Module 403 retrieves relevant video records which contain the said recognised object. Retrieving video records involves mapping image data with the control features that were extracted in module 401. Retrieval is usually implemented by pattern-matching techniques such as similarity search, partial graph matching, co-occurrence matrix, etc.

Retrieved video records generated in module 403 are preferably tagged with a level of confidence. The calculation of level of confidence is done by the pattern matching algorithm clock. In terms of the application, the level of accuracy can be increased by manual intervention in module 404.

The activity chronicle viewer 110 views the compressed video by decompressing the image data using preferably a multi-stream synchronisation technique. Synchronisation involves decompressing various data streams, synchronising those using SAMI and recreating an “original” video stream.

The present invention would greatly benefit the security industry and homeland security.

It should be appreciated that modifications and alterations obvious those skilled in the art are not to be considered as beyond the scope of the present invention.

1-12. (canceled)

13. A method of capturing and retrieving a collection of video image data including the steps of:
capturing video image data indicative of a live three-dimensional scene using at least two calibrated still CCTV cameras;
automatically identifying an object of interest within the live three-dimensional scene based on the video image data captured by the at least two calibrated still CCTV cameras;
calculating three-dimensional coordinates representing a position of the object of interest within the live three-dimensional scene; and
controlling a PTZ camera, which is calibrated with the at least two CCTV cameras, to automatically capture close-up real-time video image data of the object of interest within the live three-dimensional scene by reference to the three-dimensional coordinates representing the position of the object of interest.

14. A method as claimed in claim 13 further including the step of automatically tracking the object of interest in the captured video image data and/or in real time.

15. A method as claimed in claim 14 further including the step of automatically analysing features of the object of interest.

16. A method as claimed in claim 15 wherein the step of automatically identifying the object of interest is conducted by reference to an existing video database.

17. A method as claimed in claim 16 further including the step of constructing an activity chronicle of the object of interest as captured.

18. A method as claimed in claim 13 including the step of computing a three-dimensional image array based on video image data captured by the at least two calibrated still CCTV cameras.

19. A method as claimed in claim 13 wherein the step of automatically identifying the object of interest includes the step of performing segmentation of the three-dimensional array using background subtraction.

20. A method as claimed in claim 13 wherein the object of interest includes a person's face whereby the PTZ camera is configured to automatically capture a close-up image of the face.

21. A method as claimed in claim 13 further including the step of implementing a scheduling algorithm to control the PTZ camera to identify and track a plurality of objects of interest in the live three-dimensional scene.

22. A method as claimed in claim 21 further including the steps of
implementing a compression algorithm using background subtraction; and
implementing a decompression algorithm using multi-stream synchronisation.

23. A method as claimed in claim 22 further including the step of implementing a semantic scheme for video image data captured by the at least two still CCTV cameras.

24. A method as claimed in claim 23 further including the step of displaying non-linear and semantic tagged video information on a monitor.

25. A computerised system configured to perform the method steps of claim 13.

26. A computer-readable storage medium storing a computer program executable by a computerised system to perform the method steps in accordance with claim 13.

27. A PTZ camera configured for use in accordance with the method steps of claim 13.
